(19) United States
(12) Patent Application Publication
(10) Pub. No.: US 2008/0122582 A1
(43) Pub. Date: May 29, 2008

(54) Location Based Portable Device Feature Disabler

(75) Inventors: Richard M. Baker, Richardson, TX (US); Leonardo W. Estevez, Rowlett, TX (US); Ketan P. Malani, Murphy, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/564,400

(22) Filed: Nov. 29, 2006

(51) Int. Cl. H04B 7/00

(52) U.S. Cl. 340/10.5; 340/10.1

(57) ABSTRACT

A portable electronic device. The device comprises circuitry for performing functions in operation of the device. The device also comprises circuitry for detecting a signal representative that the device is within a location. Still further, the device comprises circuitry, responsive to the detecting circuitry, for selectively reducing a capability of at least one function of the functions in response to detecting the signal.

### CROSS-REFERENCES TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present embodiments relate to electronic devices with operational features and are more particularly directed to selectively disabling one or more of those features based on the location of the device.

Portable electronic devices have been popular for quite some time and continue to increase in popularity and functionality. Some contemporary portable electronic devices are referred to as multimedia devices, typically capable of providing both audio and visual output to a user. Multimedia functions may be combined or used in connection with other output and input data services, such as with sound in digital music and content players, internet and/or email communications, voice and data services in portable (e.g., cellular) telephones, and various input and output of personal digital assistants (“PDA”). Multimedia functionality in these and other devices also input and output still photography as well as video along with its corresponding sounds.

While the various operational functions including multimedia functions of portable electronic devices serve many useful and desirable functions, certain of these functions are not always so useful or desirable. For example, the etiquette of use of portable multimedia functions is not well established, and often users of devices with these functions choose to use such functions when others in the same vicinity would prefer such functions not be used. For example, in a quiet or private environment, such as a meeting, theater, religious institution, restaurant, school, company, club, museum, secured place, and still others, often the audio output of a portable electronic device may be bothersome. As another example, the operability of a device such as a telephone may invite its user to speak into the phone or simply operate the device for other functionality, any of which might occur at a time that is disruptive to others. As still another example, the photographic or video capture functionality of a portable device may be intrusive, undesirable, or outright prohibited at a certain location, yet a user of the device may be unaware or ignore these attributes and proceed to use the device to capture images. Numerous other examples will be appreciated by persons of skill in the art.

The preceding conflict between portable device functionality and limiting users of such devices from using such functionality is typically handled in various manners. In one approach, persons are often requested as a matter of courtesy not to use the devices in certain areas or contexts. However, persistent users may disregard, be unaware, or forget the request and proceed to use the device in a fashion that violates the request. In another approach, a person or entity seeking to prohibit the use of such a device in an area may outright prohibit the entering of the area with such a device. This prohibition is effective when adhered to by persons with access to such devices, but again the prohibition may be disregarded or unknown to a person who may proceed to enter the area with such a device and also use it in violation of the prohibition. Also, an absolute prohibition may provide more of a limit than is actually necessary and therefore may unduly burden an owner of such a device. For example, a person that is prohibited from bringing a portable telephony device into an area may have an emergency wherein they could benefit from having the device yet do not have it if they have adhered to the prohibition. As another example, a person that is prohibited from bringing a multimedia device into an area may device into an area may find the prohibition unduly burdensome or insulting if certain use of the device may seem beneficial in the area of the prohibition. Again, still other examples will be appreciated by one skilled in the art.

In view of the above, the prior art provides drawbacks and the preferred embodiments improve upon these limitations as demonstrated below.

### BRIEF SUMMARY OF THE INVENTION

In the preferred embodiment, there is a portable electronic device. The device comprises circuitry for performing functions in operation of the device. The device also comprises circuitry for detecting a signal representative that the device is within a location. Still further, the device comprises circuitry, responsive to the detecting circuitry, for selectively reducing a capability of at least one function of the functions in response to detecting the signal.

Other aspects are also disclosed and claimed.

### BRIEF DESCRIPTION OF THE SEVERAL VIEWS OF THE DRAWING

FIG. 1 illustrates a general diagram of a handset in connection with which a preferred embodiment may be implemented.

FIG. 2 illustrates an electrical functional block diagram of certain aspects of the handset of FIG. 1.

FIG. 3 illustrates a flowchart of a methodology of a portion operation of the handset of FIG. 1.

FIG. 4 illustrates different locations, each with a respective portable handset therein and where two such locations fall within a zone corresponding to a respective RFID tag.

FIG. 5 illustrates an alternative flowchart of a methodology of partial operation the handset of FIG. 1.

FIG. 6 illustrates the construction of an alternative architecture for a handset 10′ according to another preferred embodiment.

### DETAILED DESCRIPTION OF THE INVENTION

The present invention is described below in connection with a preferred embodiment, namely as implemented into a mobile electronic device that implements various operational functionality, such as may be included in a device that includes the functionality of a cellular telephone or multimedia device, by ways of example. The present inventors believe that this invention is especially beneficial in such applications. However, the invention also may be implemented in, and provide significant benefit to, other electronic devices as well, or the preceding devices may include additional functionality (e.g., such as from a personal digital assistant (“PDA”)). Accordingly, it is to be understood that the following description is provided by way of example only and is not intended to limit the inventive scope.

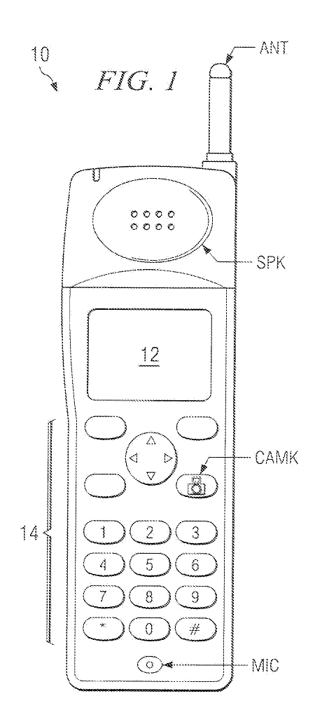

FIG. 1 illustrates a block diagram of a wireless telephone handset 10. The general nature of various aspects of handset 10 is known in the art, but novel aspects are added thereto and improve handset 10 for reasons appreciated throughout the remainder of this document. In the example of FIG. 1, handset 10 provides the conventional human interface features, including microphone MIC, speaker SPK, visual display 12 which may serve solely as an output or which also may include an input functionality such as through a touch screen or write pad functionality, and keypad 14. Keypad 14 includes the usual keys for a wireless telephone handset, including numeric keys 0 through 9, the * and # keys, and other keys as in conventional wireless telephone handsets or that may be included with such handsets, such as soft keys adjacent display 12 as well as directional keys for purposes of navigating a cursor or the like on display 12. Still further in connection with keypad 14, handset 10 is shown to include a camera key CAMK in order to actuate a camera function of handset 10, where the lens of such a camera is not shown in FIG. 1 as often it is on the rear side of the handset case and, thus, is not visible in the frontal perspective of the Figure. Note also in this regard that such a camera may be for use in still or video image photography, or both. In any event, according to a preferred embodiment and as detailed later, the functionality of these interface features to either receive input from, or provide output to, a user, may be selectively limited, that is, reduced reduced or restricted, in response to handset 10 detecting that headset 10 is within a vicinity or location in which it is desired to so limit such function(s).

FIG. 2 illustrates the construction of an architecture for handset 10 according to a preferred embodiment. Of course, the particular architecture of a wireless handset (or other portable device within the inventive scope) may vary from that illustrated in FIG. 2, and as such the architecture of FIG. 2 is presented only by way of example. As shown in FIG. 2, the operational functionality of handset 10 is generally controlled in part by a processor 16, that is coupled to visual display 12, keypad 14, a camera CAM (which is controlled by camera key CAMK described above), and a power management function 18. Processor 16 in a preferred embodiment may include a core and separate digital signal processor (“DSP”), although for simplicity these devices are not separately shown but may be included on a single integrated circuit as a combined processor such as a Texas Instruments Incorporated OMAP™ processor. Processor 16 includes a programmable logic device, such as a microprocessor or microcontroller, that controls the operation of handset 10 according to a computer program or sequence of executable operations stored in program memory. Preferably, the program memory is on-chip with processor 16, but alternatively may be implemented in read-only memory (“ROM”) or other storage in a separate integrated circuit. The computational capability of processor 16 depends on the level of functionality required of handset 10, including the “generation” of wireless services for which handset 10 is to be capable. As known in the art, modern wireless telephone handsets can have a great deal of functionality, including the capability of Internet web browsing, email handling, digital photography, game playing, PDA functionality, and the like. Such functionality is in general controlled by processor 16. In addition, processor 16, and possibly through its separate DSP component if so included, performs the bulk of the digital signal processing for signals to be transmitted and signals received by handset 10. These functions include the necessary digital filtering, coding and decoding, digital modulation, and the like. As detailed later, processor 16, again possibly through its DSP, is operable to reduce or disable operational functionality of handset 10 when handset 10 is in certain locations. In any event, contemporary examples of DSPs suitable for use as a DSP in handset 10 according to this embodiment include the TMS320c5x family of digital signal processors available from Texas Instruments Incorporated, although other DSPs also may perform the functionality detailed herein. Power management function 18 distributes regulated power supply voltages to various circuitry within handset 10 and manages functions related to charging and maintenance of the battery of handset 10, including standby and power-down modes to conserve battery power.

Handset 10 also includes radio frequency (“RF”) circuitry 20, which is coupled to an antenna ANT and to an analog baseband circuitry 22. RF circuitry 20 includes such functions as are necessary to transmit and receive the RF signals at the specified frequencies to and from a wireless telephone communications network. RF circuitry 20 is thus contemplated to include such functions as modulation circuitry and RF input and output drivers. Analog baseband circuitry 22 processes the signals to be transmitted (as received from microphone MIC) prior to modulation, and the received signals (to be output over speaker SPK) after demodulation (hence in the baseband), to apply the necessary filtering, coding and decoding, and the like. Further, either or both microphone MIC and speaker SPK, and analog baseband circuitry, may provide functions in addition to telephony, such as in connection with multimedia applications. Such functions may be used for notification, entertainment, gaming, data input/output, PDA functionality, and the like. Lastly, typical functions included within analog baseband circuitry 22 include an RF coder/decoder (“CODEC”), a voice CODEC, speaker amplifiers, and the like, as known in the art.

Completing FIG. 2 and in a preferred embodiment, handset 10 also includes a radio frequency identification (“RFID”) transceiver 24, coupled to processor 16 and RF circuitry 20. By way of introduction, RFID transceiver 24, sometimes referred to in the art as a scanner or reader, includes circuitry, as may be ascertained by one skilled in the art, to issue a radio frequency signal, via RF circuitry 20 and antenna ANT, so as to interrogate an area proximate handset 10 to determine if one or more RFID tags are located in that area. If an RFID tag is thusly within the vicinity, the tag in response to the interrogate signal broadcasts a response, which therefore is received by antenna ANT and communicated to communicated to RFID transceiver 24 via RF circuitry 20. Transceiver 24 reports the results of this interrogation to processor 16, and preferably to its DSP if so included. Transceiver 24 may be constructed by one skilled in the art, with examples readily known or commercially available, such as from Texas Instruments Incorporated. In response, therefore, processor 16 (or the DSP thereof) is informed whether an RFID tag with a particular identification is located within the area and, if so, then processor 16 may selectively reduce or disable part of the operational functionality of handset 10, as further detailed below.

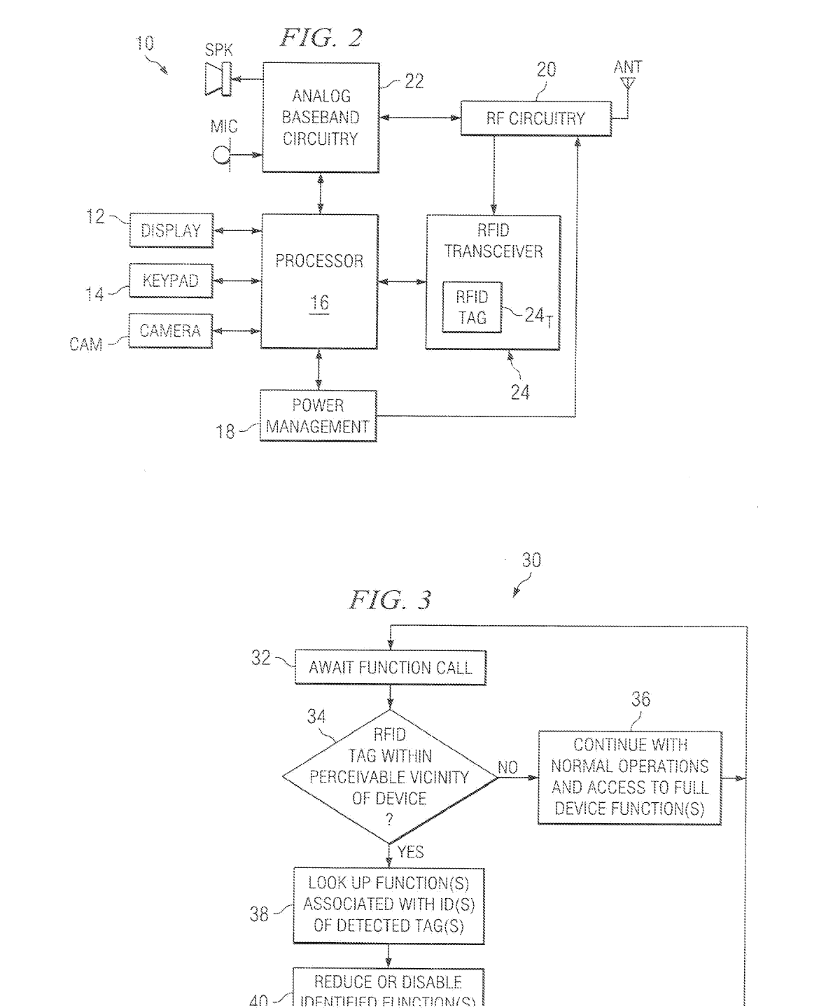

FIG. 3 illustrates a flowchart of a preferred embodiment method 30 for handset 10. Method 30 may be performed by various combinations of software and hardware of handset 10, such as by computer readable media (i.e., programming in program memory) to processor 16 and the circuitry therein, along with resulting control of other features of handset 10 as appreciated below. Further, method 30 only illustrates a portion of the operations of handset 10, as these operations are germane to the preferred embodiment but may be combined with numerous other functions that are now included or may in the future be included within a device of the type of handset 10.

Looking then to method 30, it is presumed to occur after start-up or initialization or reset of headset 10, and note that method 30 may be combined with other functions known or ascertainable in the art. In any event, method 30 begins with a step 32, wherein headset 10 awaits a function call in processor 16, that is, when the user or some other activity occurs that thereby calls upon processor 16 to perform a certain function. Note that the specific function that is included within step 32 may be any one of various functions defined by one skilled in the art where those functions are a subset of all functions performable by handset 10—the function subset selection will be appreciated after an understanding of the remaining teachings of this document, where the selected functions are those, or occur in connection with those, that may be desirable for disabling or affecting when handset 10 is in a certain type of area or location. To appreciate such functions, assume then for example that in one preferred embodiment the defined function subset to be handled by step 32 involves any function of handset 10 that affords the user the ability to provide data input to, or receive data output from, headset 10, in any form (e.g., with respect to visual display 12, keypad 14, speaker SPK, microphone MIC, or camera CAM). Thus, when handset 10 is operated in a form that calls for such a function, such as when the user presses a button on handset 10 that calls for such a function, then step 32 occurs and method 30 continues from step 32 to step 34.

Before proceeding with a discussion of other steps in method 30 of FIG. 3, to further appreciate method 30 and all its steps, FIG. 4 illustrates a block diagram of locations or area examples for the application of method 30. In this regard, FIG. 4 illustrates two RFID zones Z₁ and Z₂, each depicted by a dashed circle to denote that the zone is generally an RFID detectable area as further appreciated in the remainder of this document. Also, for sake of example, assume that RFID zone Z₁ is defined in an area that includes part or all of a movie theater and RFID zone Z₂ is defined in an area that includes an office meeting room. These example locations or areas are chosen as types of areas in which the preferred embodiment is desirable in certain circumstances. In the preferred embodiment, each RFID zone Zₓ is defined by virtue of having a respective RFID tag Tₓ in the zone; thus, in FIG. 4, zone Z₁ is defined by a tag T₁ and zone Z₂ is defined by a tag T₂. More specifically, therefore, and per the RFID art, a tag such as tag T₁ is detectable by an RFID transceiver (or reader or scanner) so long as the transceiver is within an approximate radius R₁ of tag T₁, thereby defining the general boundary of zone Z₁. Similarly, therefore, tag T₂ is detectable by an RFID transceiver so long as such a transceiver is within an approximate radius R₂ of tag T₂, thereby defining the general boundary of zone Z₂. Of course, as known in the art, radii R₁ and R₂ may differ and various factors may affect the actual length of each radius. Further, each tag Tₓ may be constructed by one skilled in the art, with examples readily known or commercially available, such as from Texas Instruments Incorporated.

Also shown in FIG. 4 are three handsets 10₁, 10₂, and 10₃. Each handset 10ₓ is presented as an example of a separate device like handset 10 of FIG. 1 and, therefore, includes the circuitry of FIG. 2 and is operable to perform method 30 of FIG. 3. However, to complete the examples, handset 10₁ is within zone Z₁, handset 10₂ is within zone Z₂, and handset 10₃ is not within an RFID zone. Moreover, since the preferred embodiment relates to a portable or mobile electronic device and FIG. 4 depicts different locations, then FIG. 4 alternatively could be considered to present one handset 10, with the movement of that device at different times to three different locations, shown in FIG. 4 as 10₁, 10₂, and 10₃.

Returning now to FIG. 3 and its method 30, in step 34, having been reached because a function in a certain subset of functions performable by handset 10 is called, then RFID transceiver 24 of handset 10 determines whether an RFID tag is within the perceivable vicinity of the handset device; thus, in the phraseology of FIG. 4, the handset 10ₓ, preferably by way of its RFID transceiver 24 and also with processor 16, determines whether it is within a radius Rₓ of a tag Tₓ, that is, the handset determines whether it is within an RFID zone. The manner of performing this determination is known in the RFID art, whereby in general an RFID transceiver issues a wireless interrogating signal and, if an RFID tag is within a certain distance of the transceiver, then the RFID interrogating signal causes an excitation of circuitry within the RFID tag which in turn issues a responsive wireless signal to the RFID transceiver; moreover, the responsive signal will include an identification of the RFID tag, which typically includes a unique identifier such as a unique number that is received and understood by the transceiver. Thus, in the example of the handsets of FIG. 4, handset 10₃ will make a negative finding for the query of step 34 because that handset is not within an RFID zone, while handsets 10₁ and 10₂ will each make a respective affirmative finding of step 34 as each will detect a unique identifier for the respective tags T₁ and T₂. A negative finding of step 34 causes method 30 to proceed to step 36, while a positive finding of step 34 causes method 30 to continue to step 38.

In step 36, a handset operating per method 30 continues with normal operation and is intended therefore to have full access to the operational functionality of that handset. Thus, in the example of FIG. 4, handset 10₂, having determined that it is not within an RFID zone, operates per step 36 and provides its user with all operational functionality of which the handset is capable. In this sense, therefore, method 30 is completely transparent to that user as a result of the handset not being located within an RFID zone. Moreover, also transparent to the user is that while normal operations continue, method 30 returns from step 36 to step 32 to thereby await a next function call, and upon the call of such a function (from the above-described subset of functions), method 30 then proceeds to step 34 as detailed herein.

In step 38, a handset operating per method 30 responds to the step 34 determination that the handset is within an RFID zone. Preferably, processor 16 of the handset (e.g., handset 10₁ or 10₂ of FIG. 4) performs a look up of the unique identifier of the tag Tₓ that issued a responsive signal in step 34, where the look up is in any manner operable to computing devices such as by processor 16 to a memory, which may be either internal or external from the processor. In any event, in the preferred embodiment, a function or functions are associated with that identifier so that when the look up is performed, if the identifier is found (e.g., in memory), then linked to that identifier is the associated function(s), such as may be linked in various forms such as through pointers or in a table. Note also that the communication and/or storage of the identifiers and the associated function(s) may be achieved in various ways, such as at the time the handset is manufactured or with later updates, where the latter may be communicated via telephony or download to the handset, such as through periodic updates or the like. In any event and to appreciate the association of a looked up identifier and certain functions, for example, for tag T₁ in FIG. 4, assume for sake of easy reference that its identifier is “T₁,” whereas in fact a much more complicated code is likely to be used in the RFID art. Thus, in step 38, processor 16 of handset 10₁ performs a look up of identifier “T₁” to determine what function(s), if any, is found and associated with that identifier. Further, assume also in the example of FIG. 4 that a collection of two operational functions are associated with tag T₁, namely: (1) the operation of camera CAM; and (2) the operation of speaker SPK for purposes of sounding a ring to the handset user. Accordingly, in step 38, the look up of tag T₁ by handset 10₁ determines that these two functions are associated with tag T₁. Next, method 30 continues to step 40.

In step 40, the handset 10ₓ that determined that it is within an RFID zone and has identified one or more functions associated with the RFID tag Tₓ of that zone then partially reduces, or fully reduces (i.e., disables) those identified functions. Thus, continuing the example of the preceding paragraph, when handset 10₁ reaches step 40, the handset, preferably using the control and other functionality of processor 16 completely disables the operation of camera CAM and disables speaker SPK for purposes of sounding a ring to the handset user. As a result, so long as handset 10₁ remains in zone Z₁, then if a user of handset 10₁ attempts to use the handset 10ₓ for either of these functions, the handset 10ₓ will not permit the user to do so. In the present example, therefore, one skilled in the art should appreciate that in the given environment of the zone Z₁ movie theater, the user of handset 10₁ is effectively prohibited from using the camera feature of his/her handset, which is likely a desirable result in that such a user cannot capture images of the film at the theater. Moreover, if the handset receives a call, speaker SPK is disabled from presenting a ring signal which could otherwise disturb or annoy other patrons at the movie theater of zone Z₁. However, note that any other operational functionality in this example of handset 10₁ remains usable. Thus, the user thereof may still receive a call and be notified of that call by vibration and may still answer the call and respond to it. Once step 40 is achieved, method 30 returns to step 32 to await a next function call and the method repeats in the manner just described. Thus, at each subsequent function call this check can be repeated, so that if the user of handset 10 moves it to a different area (e.g., leaves or enters a zone in FIG. 4), then handset 10 will permit the occurrences of steps 34 and the steps thereafter to reduce or disable functions per step 40 if handset 10 is so directed by an RFID tag as detailed above in connection with FIG. 3. Note also that while not shown, a timer also may be associated with the selective reduction of step 40. In other words, a timer could be initialized and begin counting at the occurrence of step 40 so that the flow does not return to step 32 until the timer reaches a predetermined threshold. In this manner, therefore, for the entirety of the time before the timer reaches its threshold, the function reduction of step 40 is in effect even if the user of handset 10 during that time attempts to call another function. Once the timer threshold is reached, however, the flow returns to step 32 and, upon the next function call, handset 10 proceeds as above to determine if at that point the handset 10 detects an RFID tag.

RFID Zone Z₂ of FIG. 4 provides another example to demonstrate that a different set of functions may be associated with a different RFID zone Zₓ and its corresponding tag Tₓ. Thus, recalling that zone Z₂ in the example is an office meeting room, the functions associated with tag T₂ may differ from that of tag T₁. By way of example, therefore, assume that tag T₂ is associated with all operation: (i) of the handset speaker SPK to produce any sound; (ii) microphone MIC to produce electrical signals in response to sound; and (iii) additional functionality used to receive an incoming call. In this manner, therefore, handset 10₂ detects in step 34 that is it within the perceivable vicinity of RFID tag T₂ and, in response, in step 38 it looks up the functions associated with tag T₂, where those functions are as just described. Next, therefore, when step 40 is reached by handset 10₂, then step 40 disables all of these features associated with tag T₂, thereby precluding the user of handset 10₂ from making or receiving any call while in zone Z₂.

From the preceding, it may be appreciated that the preferred embodiments provide an apparatus and method for use with a portable device having various operational functionality, where a portion (or all) of that functionality is selectively disabled depending on the location of the device. Thus, the inventive portable device will automatically disable one or more of its features in response to the location of the device. In the preferred embodiment, the selective disablement is achieved using RFID technology, providing various benefits over other possible approaches. Further, the specific functionality may be any type of input or output from the portable device, and may more specifically include the operation of microphone MIC, speaker SPK, display 12, and any one or more of keys on keypad 14. Further, any one or more of these items may be limited in certain of its functions, such as by permitting partial use of speaker SPK to output certain sounds or display 12 to output certain items, while still limiting the entirety of the functionality of these features as would occur when the device is outside of a detected RFID zone. As a result, the disadvantages discussed in the Background Of the Invention section are successfully overcome.

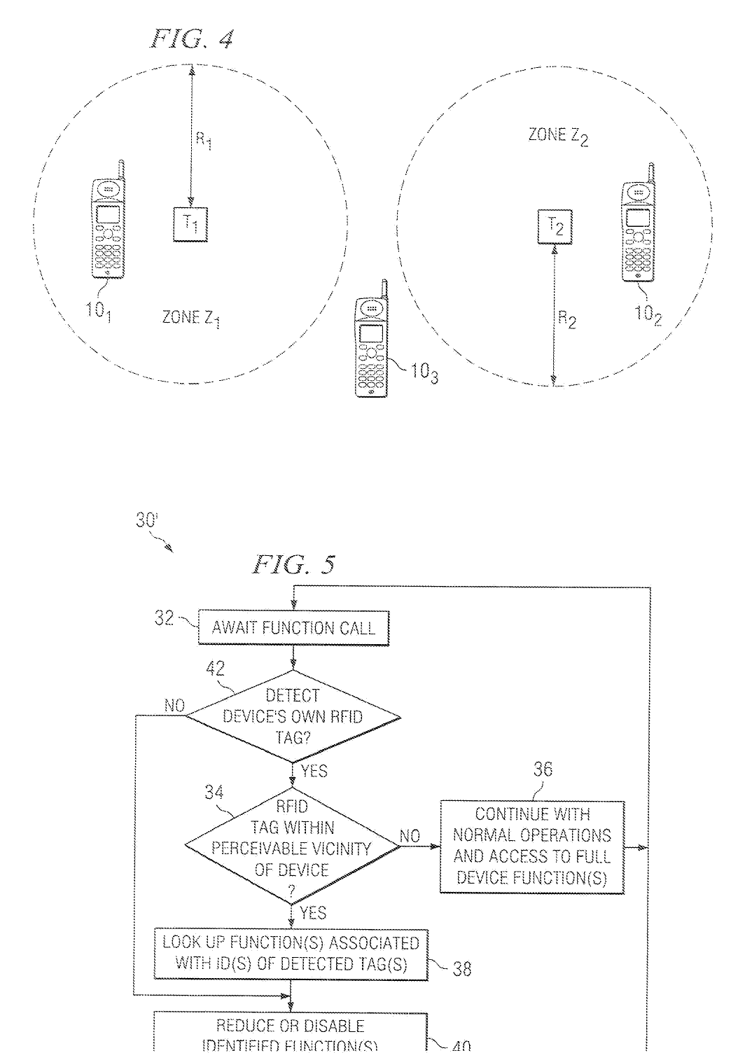

FIG. 5 illustrates method 30 from FIG. 3 with one additional step, as may be implemented in an alternative preferred embodiment and, thus, the method of FIG. 5 is indicated as 30′. Method 30′ differs from method 30 in that the former includes one additional step 42, inserted between steps 32 and 34 of method 30 in FIG. 3. Further, to perform method 30′, the alternative preferred embodiment also includes an RFID tag 24_{T} in handset 10, as will now be noticed as also shown in FIG. 2 as part of RFID transceiver 24.

Turning to method 30′, step 42 provides an aspect to apply step 40 if there is significant RF interference. Particularly, following a function call in step 32, method 30′ continues to step 34, where handset 10 determines if it detects its own RFID tag. This detection may be achieved using the same circuitry of handset 10 as used for other RFID interrogations, such as for example any one or more of RFID transceiver 24, RF circuitry 20, antenna ANT, and processor 16. Thus, in step 42, handset 10 issues an interrogation signal and under normal operation of method 30′ there is the expectation that tag 24₁ will respond with its tag identifier, and the identifier may be confirmed by processor 16, again such as by way of a lookup function. If in step 42 handset 10 so detects its own RFID tag 24_{T}, then method 30′ continues to step 34. To the contrary, if in step 42 handset 10 does not, or fails to, detect its own RFID tag 24_{T}, then method 30′ proceeds directly from step 42 to step 40.

Certain observations now may be made of the alternative embodiment illustrated by method 30′. In particular, if handset 10 is in an area where considerable RF interference occurs, then such interference could be misinterpreted and/or disturb the proper application of step 40, which potentially could permit functions of handset 10 to be allowed at a time when instead reductions of such functions are intended. In other words, RF interference could effectively prohibit handset 10 from detecting a nearby RFID tag that is intended to reduce the handset functionality, thereby permitting handset 10 to fully function when, in fact, a nearby RFID tag may exist and be so located so as to reduce the handset functionality. However, step 42 contemplates a response if handset 10 cannot properly detect its own RFID tag 24_{T}, that is, by advancing directly to step 40 so as to reduce the handset functionality even without detecting a nearby RFID tag. Thus, step 42 of method 30′ seeks to anticipate the possibility of an intended RF jamming attempt. Specifically, as the preferred embodiment becomes more ubiquitous in use, wrongdoers could attempt to cause portable devices so equipped to continue to fully function by providing jamming interference in certain areas or some other signal that attempts to overpower RFID transceiver 24 so that RFID tags within the communications range of the transceiver cannot be read. As a result, method 30′ includes step 42 as a failsafe in that in such an environment, the included tag 24_{T} within handset 10 also will not be successfully read, and method 30′ in response directs the flow directly to step 40 and thereby reduces functionality of the handset. Thereafter, flow is returned to step 32 (either with or without a timer as mentioned above) and, thus, at each subsequent function call this check can be repeated, so that if the user of handset 10 moves it to a different area or if the interference subsides, then handset 10 will permit the occurrences of steps 34 and the steps thereafter to reduce or disable functions per step 40 if handset 10 is so directed by an RFID tag as detailed above in connection with FIG. 3.

FIG. 6 illustrates the construction of an alternative architecture for a handset 10′ according to another preferred embodiment. In general, handset 10′ includes numerous of the blocks and aspects shown with respect to handset 10 in FIG. 2 and for those features like reference numbers are carried forward from FIG. 2 to FIG. 6. However, as detailed below, handset 10′ implements the preferred functionality reducer that is achieved via certain hardware aspects. As a result, handset 10′ can be implemented with little or no modifications to existing handset software and with less significance on the operation of processor 16.

Turning to the differences depicted in FIG. 6 of handset 10′ as compared to handset 10 of FIG. 2, power management function 18 is shown coupled to a power management bus PMB. Power management bus PMB is coupled to various items in handset 10′, namely, to: (i) speaker SPK; (ii) microphone MIC; (iii) display 12; (iv) keypad 14; (v) camera CAM; and (vi) RF circuitry 20. The intention of the illustrated couplings of bus PMB in this manner is to illustrate that power management function 18 may control power to each of these different items, either separately or collectively. Moreover, while bus PMB is shown as coupled to items (i) through (vi), one skilled in the art should appreciate that additional items could be added thereto or certain of these items could be eliminated from this coupling, in which case function 18 controls only those items to which it is coupled. Lastly, note that a signal connection SC is shown from RFID transceiver 24 to power management function 18, and for sake of reference and as a possible implementation approach this connection is via a physical pin 18p on function 18, where pin 18_{P} could be a dedicated pin or a multiplexed function on a pin that shares other functionality.

With the additional couplings of handset 10′ described above and shown in FIG. 6, note that handset 10′ also performs at least some steps from method 30 or 30′, of FIGS. 3 or 5, so as to selectively reduce (either partially or fully disable) handset functionality. Thus, again RF transceiver 24 may detect the presence of an RFID tag in step 34, in which case it is desired to reduce functionality of handset 10′. Thus, method 30 (or 30′) continues to step 38 to perform a look up of the unique identifier of the detected tag and the function(s) corresponding to that tag for selective reduction. In response and continuing then to step 40, the function is reduced (either in part or in full). Specifically, transceiver 24 provides a signal, via signal conductor SC, to pin 18_{P}. This signal, for example, may cause the voltage on pin 18_{P} to change (the pin may be pulled high/low normally). In response, power management function 18 asserts the proper control to power management bus PMB so as to reduce the power to one or more of items (i) through (vi) detailed above, thereby reducing the functionality of that feature. Note that the item or items to be so affected may be in response to the look up in step 38. Alternatively, step 38 may be eliminated and the function to be reduced may be predetermined and fixed in handset 10′ or may be set via some internal register(s) to thereby enable a configurable part of handset 10′ to be powered down in the presence of the RF signal which was detected and thereby caused the voltage on pin 18_{P} to change. Given the preceding, one skilled in the art should now appreciate that in handset 10′, again functionality may be selectively reduced in response to the detection of an RFID tag proximate a handset, but here note that such reduction may be achieved without operation of processor 16. Instead, a hardware approach is provided so as not to interfere with the software of processor 16, whereby in the preferred embodiment approach this is achieved by reducing power to the circuits that otherwise would provide the function that is being reduced.

From the above, it may be appreciated that the preferred embodiments provide a portable device with various aspects, including the ability to reduce operational functionality of a portable device in response to the location of the device. In a preferred embodiment, such functionality reduction is achieved by RFID communications. However, alternative preferred embodiments may be constructed using various other wireless communications, whereby a handset (e.g., 10 or 10′) detects the presence of a signal based on the location of the handset, and in response to that signal handset 10 reduces part of its functionality. For example, Bluetooth, Zigbee, and WiFi are increasingly used wireless communication technologies. One skilled in the art would typically anticipate that such technologies require pairing to establish a two-way communication; however, it is recognized in connection with the preferred embodiments that such technologies also may be used to support methods 30 and 30′ without fully establishing the two way communication. Specifically, either of these protocols commences communication by announcing some type of identification (e.g., a code, a MAC address, or other). Thus, in step 34 of either method 30 or 30′, rather than issuing an interrogating signal and then potentially detecting an RFID tag in response thereto, handset 10 (or 10′) could search to detect the mere presence of a signal, such as the announcement of a Bluetooth or Zigbee identification by a Bluetooth or Zigbee transmitting device. No response by handset 10 (or 10′) to the transmitting device is necessary to achieve these methods (although one could be provided), and thus the method could then proceed with steps 38 and 40, having determined from the announced identification that functionality reduction is desired in the area proximate the transmitting device. Still further, alternative preferred embodiments may be achieved using other ISM (Industrial, Scientific and Medical) band communication technologies as well as the cellular phone modem that typically communicates with a cellular phone tower, whereby in response to a signal from such ISM band communication technologies that is provided to the handset based on the handset location, the handset reduces its functionality.

While various alternatives have been provided according to preferred embodiments, still others are contemplated and yet others may be ascertained by one skilled in the art. For example, while certain input or output functions have been shown to be selectively reduced in the earlier examples, other functions also may be selectively reduced. As an instance of this example, reducing certain functions may be achieved by reducing the quality that a feature otherwise provides when it is not limited, while not fully disabling the feature. As more specific examples of this feature quality reduction, in a preferred embodiment that captures audio, video, or imagery, and in response to a detection of a nearby RFID tag, the operation of step 40 may allow the capture device to capture at a reduced quality level, such as at lower resolutions or audio sampling rates. As a result, handset 10 (or 10′) still provides some use, but the user thereof is prevented from making high quality reproductions of protected content. Indeed, a specific implementation of this approach is to allow a VGA resolution image capture in an area (e.g., art museum), but not a large megapixel capture that could be used to make and sell prints. Given the preceding, therefore, one skilled in the art should further appreciate that while the present embodiments have been described in detail, various substitutions, modifications or alterations could be made to the descriptions set forth above without departing from the inventive scope, as is defined by the following claims.

1. A portable electronic device, comprising:
circuitry for performing functions in operation of the device;
circuitry for detecting a signal representative that the device is within a location; and
circuitry, responsive to the detecting circuitry, for selectively reducing a capability of at least one function of the functions in response to detecting the signal.

2. The portable electronic device of claim 1, and further comprising:
circuitry for issuing an interrogation signal to detect if the device is within a location that includes a responder device for providing a responsive signal to the interrogation signal, wherein the responsive signal is the signal representative that the device is within a location; and
wherein the circuitry for selectively reducing a capability of at least one function of the functions is operable in response to detecting that the location includes a responder device for providing a responsive signal to the interrogation signal.

3. The portable electronic device of claim 2 wherein the circuitry for issuing an interrogation signal comprises radio frequency identification circuitry.

4. The portable electronic device of claim 2 wherein the responder device comprises a radio frequency identification tag.

5. The portable electronic device of claim 4 wherein the circuitry for selectively reducing a capability comprises circuitry for associating the frequency identification tag with the at least one function.

6. The portable electronic device of claim 1:
wherein the circuitry for issuing an interrogation signal comprises radio frequency identification circuitry; and
wherein the responder device comprises a radio frequency identification tag.

7. The portable electronic device of claim 6 wherein the circuitry for selectively reducing a capability comprises circuitry for associating the frequency identification tag with the at least one function.

8. The portable electronic device of claim 7 wherein the at least one function is an input function.

9. The portable electronic device of claim 8 wherein the at least one function is an output function.

10. The device of claim 7 wherein the at least one function is an input or output function.

11. The portable electronic device of claim 2 wherein the at least one function is an input function.

12. The portable electronic device of claim 2 wherein the at least one function is an output function.

13. The portable electronic device of claim 2 and further comprising a speaker, wherein the at least one function comprises operating the speaker to produce a sound.

14. The portable electronic device of claim 2 and further comprising a microphone, wherein the at least one function comprises operating the microphone to produce one or more signals in response to sound.

15. The portable electronic device of claim 2 and further comprising a camera, wherein the at least one function comprises operating the camera to record at least one image.

16. The portable electronic device of claim 2 and further comprising a keypad, wherein the at least one function comprises providing at least one signal in response to use of at least one key on the keypad.

17. The portable electronic device of claim 2:
wherein the circuitry for issuing an interrogation signal is further for detecting if the device is within a location that includes a plurality of responsive devices, wherein each responsive device is for providing a respective responsive signal to the interrogation signal; and
circuitry, responsive to the circuitry for issuing an interrogation signal, for selectively reducing a respective capability of at least one function of the functions in response to each of the respective responsive signals.

18. The portable electronic device of claim 2 wherein the circuitry for reducing a capability comprises circuitry for associating a response from the responsive device with the at least one function.

19. The portable electronic device of claim 2 wherein the circuitry for selectively reducing comprises circuitry for selectively fully disabling the capability of the at least one function.

20. The portable electronic device of claim 2 wherein the circuitry for selectively reducing a capability of at least one function comprises circuitry for reducing power to a functional element that provides the at least one function.

21. The portable electronic device of claim 2 wherein the circuitry for selectively reducing a capability of at least one function comprises circuitry for reducing the capability for a period of time defined by a timer.

22. The portable electronic device of claim 2 wherein the responder device comprises a first responder device, and wherein the portable electronic device further comprising a second responder device for issuing a response to the interrogation signal, wherein the circuitry for selectively reducing a capability of at least one function of the functions is further operable to selectively reduce the capability if no response by the second responder device is detected by the circuitry for detecting.

23. The portable electronic device of claim 22 wherein the first and second responder devices both comprise a radio frequency identification tag.

24. The portable electronic device of claim 2 wherein the circuitry for selectively reducing a capability comprises a processor for selectively reducing the capability as provided to a user of the portable electronic device.

25. The portable electronic device of claim 1 wherein the at least one function is selected from a set consisting of an input function and an output function.

26. The portable electronic device of claim 1 and further comprising a functional element and the at least one function comprises operating the functional element, wherein the functional element is selected from a set consisting of a speaker, a microphone, a camera, and a keypad.

27. The portable electronic device of claim 1 wherein the circuitry for detecting a signal comprises circuitry for detecting a signal selected from a set consisting of Bluetooth, Zigbee, and ISM band.

28. The portable electronic device of claim 1 wherein the circuitry for selectively reducing a capability of at least one function comprises circuitry for reducing power to a functional element that provides the at least one function.

29. The portable electronic device of claim 1 wherein the circuitry for selectively reducing a capability of at least one function comprises circuitry for reducing the capability for a period of time defined by a timer.

30. The portable electronic device of claim 1 wherein the circuitry for selectively reducing a capability comprises a processor for selectively reducing the capability as provided to a user of the portable electronic device.

31. A method of operating a portable electronic device, comprising:
in various times performing functions in operation of the device;
detecting a signal representative that the device is within a location; and
responsive to the detecting step, selectively reducing a capability of at least one function of the functions in response to detecting the signal.

32. The method of claim 31 wherein the step of selectively reducing comprises selectively reducing for a period of time determined by a timing function performed the portable electronic device.

33. The method of claim 31, and further comprising:
issuing an interrogation signal to detect if the device is within a location that includes a responder device for providing a responsive signal to the interrogation signal, wherein the responsive signal is the signal representative that the device is within a location; and
wherein the selectively reducing step occurs in response to detecting that the location includes a responder device for providing a responsive signal to the interrogation signal.

34. The method of claim 33:
wherein the circuitry for issuing an interrogation signal comprises radio frequency identification circuitry; and
wherein the responder device comprises a radio frequency identification tag.

35. The method claim 33 wherein the step of reducing a capability comprises associating a response from the responsive device with the at least one function.

36. The method of claim 31 wherein the step of selectively reducing a capability of at least one function comprises reducing power to a functional element that provides the at least one function.

37. The method of claim 31 wherein the step of selectively reducing a capability comprises operating a processor to selectively reduce the capability as provided to a user of the portable electronic device.

38. The method of claim 31 wherein the at least one function is selected from a set consisting of an input function and an output function.

39. The method of claim 31 wherein the at least one function is selected from a set consisting of operating a speaker, a microphone, a camera, and a keypad.

40. The method of claim 31 wherein the step of detecting a signal comprises detecting a signal selected from a set consisting of Bluetooth, Zigbee, and ISM band.
